(19) United States
(12) Patent Application Publication
(10) Pub. No.: US 2026/0252499 A1
(43) Pub. Date: Aug. 27, 2026

(54) METHOD AND ELECTRONIC DEVICE FOR IMPLEMENTING TRUSTED EXECUTION ENVIRONMENT

(71) Applicant: REBELLIONS INC., Seongnam-si (KR)

(72) Inventor: Myunghoon CHOI, Seongnam-si (KR)

(21) Appl. No.: 19/408,265

(22) Filed: Dec. 3, 2025

(30) Foreign Application Priority Data
Feb. 27, 2025 (KR) 10-2025-0025725

(51) Int. Cl. G06F 12/14

(52) U.S. Cl. CPC G06F 12/1483; G06F 12/1408; G06F 12/145

(57) ABSTRACT

An electronic device includes a volatile memory including a secure region, a system memory management module configured to manage access to the volatile memory, and a device security manager configured to communicate with a host security manager of a host device. The device security manager is further configured to perform an authentication procedure for the electronic device based on a security protocol, receive a request for a first virtual function (VF) from the host security manager, place a first page table manager managing a first page table associated with the first VF in a secure region of the system memory management module in response to receiving the request for the first VF, and store the first page table in the secure region of the volatile memory. An access authority to the secure region of the volatile memory is granted to a root of trust (RoT) of the electronic device.

### CROSS-REFERENCE TO RELATED APPLICATION

The present application claims priority to Korean Application No. 10-2025-0025725, filed on February 27, 2025, in the Korean Intellectual Property Office, the entire disclosure of which is incorporated by reference herein.

### BACKGROUND

### Field

The present disclosure relates to a method and an electronic device for implementing a trusted execution environment.

### Description of Related Art

With development of communication technology, interconnection between electronic devices is becoming easy, and operations such as exchange of data or collaboration through the interconnection are becoming easy. In particular, as virtualization technology and cloud environments spread, cases where a plurality of virtual machines (VMs) and virtual functions (VFs) are executed in a single host device, or where operations are performed through collaboration between various electronic devices, are increasing.

On the other hand, in such a virtual execution environment, security threats such as a malicious user manipulating a VF or a VM to access data without authorization, or illegally using resources of a host device may occur. Accordingly, technology for strengthening security in a virtual execution environment such as a VF and a VM, and guaranteeing a trustworthy execution environment through mutual authentication between a host device and an electronic device is required.

### SUMMARY

The present disclosure provides a method and an electronic device for implementing a trusted execution environment for solving the problems as described above.

The present disclosure may be implemented in various ways including a method, an apparatus (system), and/or a computer program stored in a computer-readable storage medium.

According to an embodiment of the present disclosure, an electronic device for implementing a trusted execution environment (TEE). may include a volatile memory including a secure region, a system memory management module configured to manage access to the volatile memory, and a device security manager (DSM) configured to communicate with a host security manager (HSM) of a host device, and the device security manager is further configured to perform an authentication procedure for the electronic device based on a security protocol, receive a request for a first virtual function (VF) from the host security manager, place a first page table manager managing a first page table associated with the first VF in a secure region of the system memory management module in response to receiving the request for the first VF, and store the first page table in a secure region of the volatile memory, and an access authority to the secure region of the volatile memory may be granted to a root of trust (RoT) of the electronic device.

According to an embodiment, the access authority to the secure region of the volatile memory may be granted to at least one of the device security manager or the first page table manager.

According to an embodiment, the device security manager is further configured to assign a VF ID for each of a plurality of VFs including the first VF, and the electronic device may further include a runtime encryption module configured to generate a different encryption key for each VF ID, and encrypt data based on the VF ID and the encryption key corresponding to the VF ID.

According to an embodiment, the first page table manager is configured to receive a virtual address from the first VF to convert the virtual address into a physical address, and transmit a first VF ID corresponding to the first VF and the physical address to the runtime encryption module, and the runtime encryption module may be further configured to encrypt data through a first encryption key corresponding to the first VF ID to store the data in a region corresponding to the physical address of the volatile memory, or decrypt data stored in the region corresponding to the physical address of the volatile memory through the first encryption key.

According to an embodiment, the runtime encryption module may be further configured to determine whether a received VF ID is assigned by the device security manager, perform data encryption or decryption in response to determining that the received VF ID is assigned by the device security manager, and refrain from performing data encryption or decryption in response to determining that the received VF ID is not assigned by the device security manager.

According to an embodiment, the first VF is configured to transmit, to the system memory management module, a transaction layer packet (TLP) including a virtual address and data associated with the virtual address, and the system memory management module may be further configured to control access to the secure region of the system memory management module based on header information included in the transaction layer packet.

According to an embodiment, the system memory management module may be further configured to allow access to the secure region of the system memory management module if a t-bit of the transaction layer packet is 1, and block access to the secure region of the system memory management module if the t-bit of the transaction layer packet is 0.

According to an embodiment, the first page table manager of the system memory management module may include a translation buffer unit (TBU) configured to perform a translation for a virtual address, and a translation control unit (TCU) configured to access the secure region of the volatile memory to perform a page walk if translation information for the virtual address does not exist in the translation buffer unit.

According to an embodiment, the electronic device further includes a second page table manager placed in a non-secure region of the system memory management module, and access of the second page table manager to the secure region of the volatile memory may be blocked.

According to an embodiment, the first page table manager may store data in a region corresponding to a physical address corresponding to a virtual address of the volatile memory.

According to an embodiment, the security protocol may include a protocol based on a security protocol and data model (SPDM).

According to an embodiment of the present disclosure, a method for implementing a trusted execution environment, performed by an electronic device, includes performing an authentication procedure for the electronic device based on a security protocol by a device security manager of the electronic device, receiving a request for a first VF from a host security manager of a host device by the device security manager, placing a first page table manager managing a first page table associated with the first VF in a secure region of a system memory management module in response to receiving the request for the first VF by the device security manager, and storing the first page table in a secure region of a volatile memory by the device security manager, and an access authority to the secure region of the volatile memory is granted to a RoT of the electronic device, and the first VF may correspond to a first trusted execution environment virtual machine (TEE VM) included in the host device.

According to an embodiment, the method may further include assigning a VF ID for each of a plurality of VFs including the first VF by the device security manager, and by a runtime encryption module of the electronic device, generating a different encryption key for each VF ID and encrypting data based on the VF ID and the encryption key corresponding to the VF ID.

According to an embodiment, the method may further include receiving a virtual address from the first VF to convert the virtual address into a physical address by the first page table manager, transmitting a first VF ID corresponding to the first VF and the physical address to the runtime encryption module by the first page table manager, and by the runtime encryption module, encrypting data through a first encryption key corresponding to the first VF ID to store the data in a region corresponding to the physical address of the volatile memory, or decrypting data stored in the region corresponding to the physical address of the volatile memory through the first encryption key.

According to an embodiment, the method may further include transmitting a transaction layer packet including a virtual address and data associated with the virtual address to the system memory management module by the first VF, and controlling access to the secure region of the system memory management module based on header information included in the transaction layer packet by the system memory management module.

According to an embodiment, the method may further include performing a translation for a virtual address by a translation buffer unit of the first page table manager, and accessing the secure region of the volatile memory to perform a page walk if translation information for the virtual address does not exist in the translation buffer unit by a translation control unit of the first page table manager.

According to an embodiment, a second page table manager is placed in a non-secure region of the system memory management module, and access of the second page table manager to the secure region of the volatile memory may be blocked.

According to an embodiment, the method may further include storing data in a region corresponding to a physical address corresponding to a virtual address of the volatile memory by the first page table manager.

According to some embodiments of the present disclosure, for a TEE VM requiring operation in a secure environment among VMs of the host device, a trustworthy execution environment may be implemented while maintaining security between the host device and the electronic device, and through this, security of an overall system may be improved.

According to some embodiments of the present disclosure, a translation from a virtual address to a physical address may be safely managed in a secure environment. Also, a different encryption key is applied for each VF ID, so that data protection between VFs may be strengthened. By such a configuration, even if a malicious attacker attempts to access secure data, the malicious attacker cannot easily access translation information between a virtual address and a physical address, and must bypass an encryption key applied for each VF ID to decrypt data of a translated physical address, so that security may be further strengthened.

Effects of the present disclosure are not limited to the effects mentioned above, and other effects not mentioned will be clearly understood by those skilled in the art (referred to as 'those skilled in the art') in the technical field to which the present disclosure belongs from the description of the claims.

### BRIEF DESCRIPTION OF THE DRAWINGS

Embodiments of the present disclosure will be described with reference to the accompanying drawings described below, where similar reference numerals indicate similar elements, but are not limited thereto.

FIG. 1 is a block diagram illustrating a processing system according to some embodiments of the present disclosure.

FIG. 2 illustrates a processing system implementing a trusted execution environment according to some embodiments of the present disclosure.

FIG. 3 illustrates an electronic device according to some embodiments of the present disclosure.

FIG. 4 illustrates an electronic device according to some embodiments of the present disclosure.

FIG. 5 illustrates an electronic device in which a trusted execution environment is implemented according to some embodiments of the present disclosure.

FIG. 6 illustrates a method in which a host security manager and a device security manager verify reliability of an electronic device and assign a VF operating in a TEE environment according to some embodiments of the present disclosure.

FIG. 7 illustrates a process in which a VF operating in a TEE environment accesses data according to some embodiments of the present disclosure.

FIG. 8 illustrates a process in which a VF operating in a general environment accesses data according to some embodiments of the present disclosure.

FIG. 9 illustrates components of a table manager according to some embodiments of the present disclosure.

FIG. 10 illustrates a method for implementing a trusted execution environment according to some embodiments of the present disclosure.

FIG. 11 illustrates a method for implementing a trusted execution environment according to some embodiments of the present disclosure.

FIG. 12 illustrates a method for accessing data in a TEE environment according to some embodiments of the present disclosure.

### DETAILED DESCRIPTION

Hereinafter, specific details for implementation of the present disclosure will be described in detail with reference to the accompanying drawings. However, in the following description, if there is a concern that the gist of the present disclosure may be unnecessarily obscured, detailed descriptions of well-known functions or configurations will be omitted.

In the accompanying drawings, identical or corresponding components are assigned identical reference numerals. Also, in the description of the following embodiments, duplicate descriptions of identical or corresponding components may be omitted. However, even if a description of a component is omitted, it is not intended that such a component is not included in an embodiment.

Advantages and features of the disclosed embodiments, and methods for achieving them, will become clear with reference to the embodiments described later in conjunction with the accompanying drawings. However, the present disclosure is not limited to the embodiments disclosed below, but may be implemented in various different forms, and these embodiments are merely provided to make the present disclosure complete and to completely inform those skilled in the art of the scope of the invention.

Terms used in this specification will be briefly described, and the disclosed embodiments will be described in detail. General terms currently widely used as possible were selected for terms used in this specification while considering functions in the present disclosure, but the terms may vary depending on intentions of engineers engaged in the relevant field, precedents, emergence of new technologies, and the like. Also, in specific cases, there are terms arbitrarily selected by the applicant, and in this case, meanings thereof will be described in detail in the description part of the corresponding invention. Therefore, terms used in the present disclosure should be defined based on meanings that the terms have and contents throughout the present disclosure, rather than simple names of the terms.

Singular expressions in this specification include plural expressions unless the context clearly specifies as singular. Also, plural expressions include singular expressions unless the context clearly specifies as plural. throughout the specification, if a part is said to include a component, this means that the part may further include other components, not excluding other components, unless specifically stated to the contrary.

Also, the term 'module' or 'unit' used in the specification means a software or hardware component, and the 'module' or 'unit' performs certain roles. However, the 'module' or 'unit' is not meant to be limited to software or hardware. The 'module' or 'unit' may be configured to be in an addressable storage medium or may be configured to reproduce one or more processors. Therefore, as an example, the 'module' or 'unit' may include components such as software components, object-oriented software components, class components, and task components, and processes, functions, attributes, procedures, subroutines, segments of program code, drivers, firmware, microcode, circuits, data, databases, data structures, tables, arrays, or at least one of variables. Functions provided within components and 'modules' or 'units' may be combined into a smaller number of components and 'modules' or 'units', or may be further separated into additional components and 'modules' or 'units'.

According to an embodiment of the present disclosure, the 'module' or 'unit' may be implemented as a processor and a memory. The 'processor' should be interpreted broadly to include a general-purpose processor, a central processing unit (CPU), a microprocessor, a digital signal processor (DSP), a controller, a microcontroller, a state machine, and the like. In some environments, the 'processor' may refer to an application specific integrated circuit (ASIC), a programmable logic device (PLD), a field programmable gate array (FPGA), and the like. The 'processor' may refer to a combination of processing devices, such as, for example, a combination of a DSP and a microprocessor, a combination of a plurality of microprocessors, a combination of one or more microprocessors combined with a DSP core, or a combination of any other such configurations. Also, the 'memory' should be interpreted broadly to include any electronic component capable of storing electronic information. The 'memory' may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If a processor can read information from the memory and/or write information to the memory, the memory is said to be in a state of electronic communication with the processor. A memory integrated into a processor is in a state of electronic communication with the processor.

Also, terms such as first, second, A, B, (a), (b) used in the following embodiments are only used to distinguish a component from another component, and the nature, order, or sequence of the corresponding component is not limited by the term.

Also, in the following embodiments, if a component is described as being 'connected', 'coupled', or 'accessed' to another component, the component may be directly connected or accessed to the other component, but it should be understood that another component may be 'connected', 'coupled', or 'accessed' between each component.

Also, 'comprises' and/or 'comprising' used in the following embodiments do not exclude the presence or addition of one or more other components, steps, operations, and/or elements to the mentioned components, steps, operations, and/or elements.

Hereinafter, various embodiments of the present disclosure will be described in detail according to the accompanying drawings.

In the present disclosure, a 'non-volatile memory' may be a memory that maintains stored information even if power is not supplied. For example, a non-volatile memory 140 may include at least one of Read-Only Memory (ROM), Programmable Read-Only Memory (PROM), Erasable Alterable ROM (EAROM), Erasable Programmable Read-Only Memory (EPROM), Electrically Erasable Programmable Read-Only Memory (EEPROM) (e.g., NAND Flash memory, NOR Flash memory, etc.), Ultra-Violet Erasable Programmable Read-Only Memory (UVEPROM), Ferroelectric Random Access Memory (FeRAM), Magnetoresistive Random Access Memory (MRAM), Phase-change Random Access Memory (PRAM), silicon-oxide-nitride-oxide-silicon (SONOS), Resistive Random Access Memory (RRAM), Nanotube Random Access Memory (NRAM), magnetic computer storage devices (e.g., hard disks, diskette drives, magnetic tapes, etc.), optical disc drives, and 3D XPoint memory. However, the present disclosure is not limited thereto.

In the present disclosure, a 'volatile memory' may be a memory that continuously requires power to maintain stored information. For example, the 'volatile memory' may include at least one of Dynamic Random Access Memory (DRAM), Static Random Access Memory (SRAM), Synchronous Dynamic Random Access Memory (SDRAM), and Double Data Rate SDRAM (DDR SDRAM). However, the present disclosure is not limited thereto.

In the present disclosure, a trusted execution environment (TEE) may refer to an isolated execution environment for protecting operations where security is important. The trusted execution environment operates separately from a general execution environment, and by implementing the trusted execution environment, integrity and confidentiality of codes and data may be guaranteed.

In the present disclosure, page table manager and table manager may be used interchangeably.

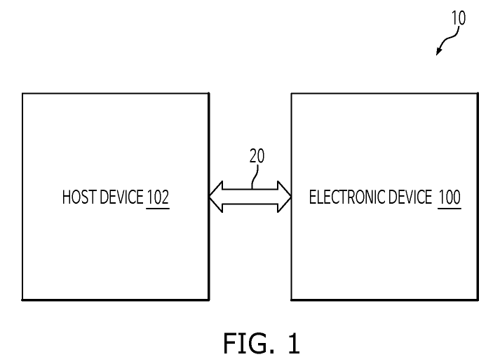

FIG. 1 is a block diagram illustrating a processing system according to some embodiments of the present disclosure.

Referring to FIG. 1, a processing system 10 according to some embodiments of the present disclosure may include a host device 102, an electronic device 100, and a host interface 20.

In an embodiment, the electronic device 100 may be a device that performs an operation using an artificial neural network. The electronic device 100 may be, for example, a device specialized in performing a deep learning operation task. However, the present embodiment is not limited thereto. In an embodiment, the electronic device 100 may include one or more accelerators such as a neural processing unit (NPU) specialized for deep learning tasks, a graphics processing unit (GPU), or a central processing unit (CPU).

The host device 102 may be a computing system that instructs the electronic device 100 to perform an operation task and retrieves a result of the operation task. For example, the host device 102 may transmit a command and/or data related to an artificial intelligence operation to the electronic device 100, and receive an artificial intelligence operation result based on the transmitted data from the electronic device 100. In an embodiment, the host device 102 may be a computing system that is not specialized for a deep learning operation task compared to the electronic device 100. However, the present embodiment is not limited thereto.

The host interface 20 may transmit data and/or a control signal between the electronic device 100 and the host device 102. The host interface 20 may transmit, for example, a command and/or data of the host device 102 to the electronic device 100, and accordingly, the electronic device 100 may perform an operation task. If the electronic device 100 completes the operation task, the electronic device 100 may transmit a result thereof to the host device 102 through an interrupt request. The host interface 20 may be, for example, PCIe (PCI Express), but is not limited thereto.

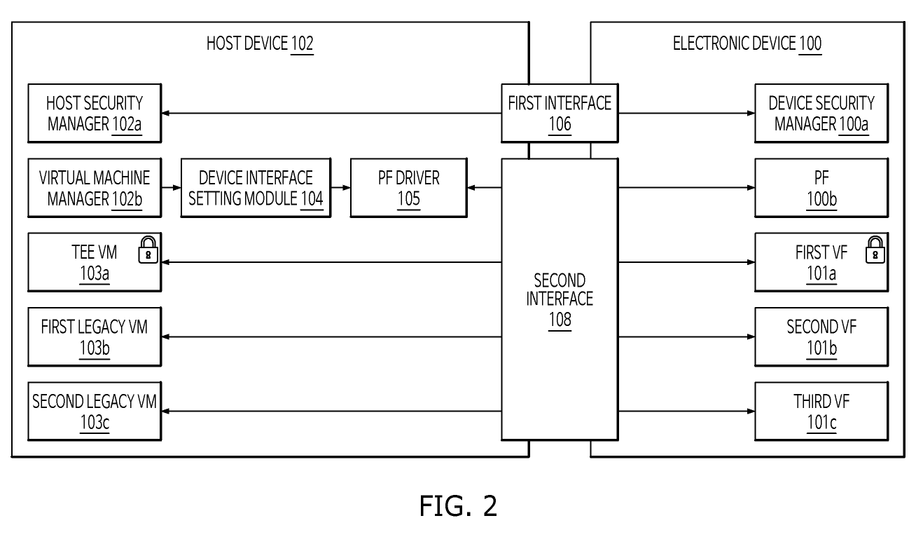

FIG. 2 illustrates a processing system implementing a trusted execution environment according to some embodiments of the present disclosure.

Referring to FIG. 2, the electronic device 100 may perform communication with the host device 102 through a second interface 108. According to an embodiment, the second interface may include a peripheral component interconnect express (PCIe) interface. The second interface 108 of FIG. 2 may correspond to the host interface 20 of FIG. 1.

The host device 102 may include a host security manager 102a, a virtual machine manager 102b, a trusted execution environment virtual machine (TEE VM) 103a, a first legacy virtual machine (legacy VM) 103b, a second legacy VM 103c, a device interface setting module 104, and a PF driver 105. However, a configuration of the host device 102 is not limited thereto. According to various embodiments, the host device 102 may omit at least one of the above-described components, and may further include at least one other component.

The host security manager 102a may be in charge of security of the host device 102. For example, the host security manager 102a may perform authentication management, data encryption, encryption key management, access authority management, security policy management, communication security, data integrity verification, software and firmware integrity verification, and the like. Accordingly, the host security manager 102a may be a most trusted root in the host device 102.

The virtual machine manager 102b may manage hardware resources of the host device 102 and support execution of a plurality of virtual machines (e.g., the TEE VM 103a, the first legacy VM 103b, the second legacy VM 103c, etc.) in a virtual environment. For example, the virtual machine manager 102b may perform virtualization and management of hardware resources, creation and deletion management of VMs, isolation between VMs, operating system support, communication management between the host device 102 and a VM, and the like.

The device interface setting module 104 may perform a role of coordinating secure communication and resource allocation between a VM and the electronic device 100 between the virtual machine manager 102b and the PF driver 105. For example, the device interface setting module 104 may receive requirements of a VM from the virtual machine manager 102b and set an appropriate virtual function (VF) to be assigned to the corresponding VM.

The PF driver 105 is executed within the host device 102, and may be in charge of creation, assignment, and control of a VF while communicating with a PF 100b of the electronic device 100. The PF driver 105 may receive a resource allocation request for a VM from the device interface setting module 104, allocate a VF in conjunction with the PF 100b of the electronic device 100, and control the VM to access a necessary resource through this.

The TEE VM 103a is a VM used to process an application or data where security and trust are important, and may perform security sensitive data processing, provision of a trustworthy execution environment, execution of a security application, encryption key and authentication management, security authentication, integrity verification, and the like.

A legacy VM (e.g., the first legacy VM 103b or the second legacy VM 103c) is a VM focused on compatibility and general virtualization tasks rather than security, and may represent a VM used to execute legacy software or an operating system.

The electronic device 100 may include a device security manager 100a, a physical function (PF) 100b, and a plurality of virtual functions (VFs) 101a-101c. However, a configuration of the electronic device 100 is not limited thereto, and some components may be omitted or added according to various embodiments.

The device security manager 100a may perform a role of applying a security policy within the electronic device 100 and configuring a trustworthy execution environment. For example, the device security manager 100a may communicate with the host security manager 102a of the host device 102 to perform functions such as device authentication, data integrity verification, access control, security key management, and the like. Also, the device security manager 100a may communicate with the host security manager 102a through a first interface 106, and perform an authentication procedure for the electronic device 100 using a security protocol. Here, the security protocol may represent a message exchange method on the first interface 106. According to an embodiment, the security protocol may include a protocol based on a security protocol and data model (SPDM), but is not limited thereto. Also, the first interface 106 may include a PCIe interface or a system management bus (SMbus), but is not limited thereto.

The PF 100b represents a physical function of the electronic device 100, and may support creation and assignment of a VF through communication with the host device 102. The PF 100b may create a VF requested by the virtual machine manager 102b in conjunction with the PF driver 105, and configure the corresponding VF to exchange data with the host device 102 through the second interface 108.

A first VF 101a, a second VF 101b, and a third VF 101c refer to virtual functions provided so that a VM can access physical resources of the electronic device 100. Referring to FIG. 2, the first VF 101a may be assigned to the TEE VM 103a, and may be isolated through a security protocol to operate in an execution environment with strengthened security. According to an embodiment, the security protocol may include a Tee Device Interface Security Protocol (TDISP). Also, the second VF 101b and the third VF 101c may be assigned to the first legacy VM 103b and the second legacy VM 103c, respectively, and may operate in an existing non-secure environment.

According to various embodiments of the present disclosure, for the TEE VM 103a requiring operation in a secure environment among VMs of the host device 102, a secure environment of the electronic device 100 is applied, so that a trustworthy execution environment may be provided. To this end, first, the host security manager 102a and the device security manager 100a may verify reliability by performing an authentication procedure for the electronic device 100 through a security protocol. If such an authentication procedure is completed, the device security manager 100a may assign the first VF 101a of the electronic device 100 to the TEE VM 103a of the host device 102, and subsequently, the device security manager 100a may control components of the electronic device 100 so that the first VF 101a operates in a secure environment. Through such a process, a trustworthy execution environment (TEE) may be implemented while maintaining security between the host device 102 and the electronic device 100, and through this, overall system security may be improved.

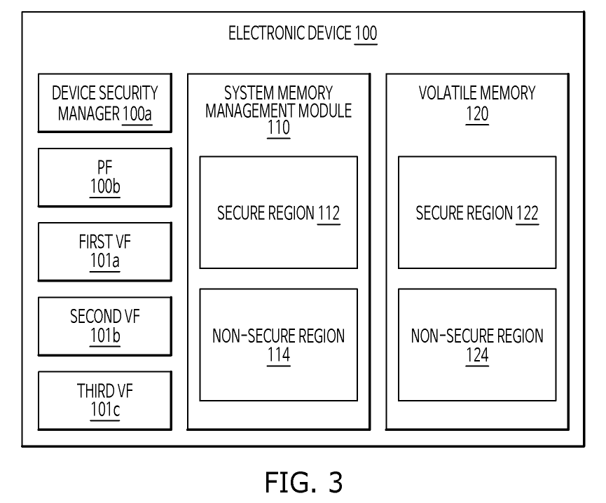

FIG. 3 illustrates an electronic device according to some embodiments of the present disclosure. Descriptions overlapping with the above description are briefly described or omitted.

Referring to FIG. 3, the electronic device 100 may include a device security manager 100a, a PF 100b, a plurality of VFs 101a-101c, a system memory management module 110, and a volatile memory 120.

The system memory management module 110 is a component that manages access and allocation of memory resources within the electronic device 100, and may include a secure region 112 and a non-secure region 114. The secure region 112 is a region where protected data and code can be stored within a trusted execution environment (TEE), and access may be allowed only by the device security manager 100a or a component following a specific security policy. Also, the secure region 112 may include a page table manager that manages page mapping information so that a TEE VM can find data attempting access, and through this, a virtual address translation task requiring security may be safely performed. The non-secure region 114 is a region where data used in a general operating environment can be stored, and may be utilized for memory allocation that does not require security verification. Also, the non-secure region 114 may include a page table manager that manages page mapping information so that a VM operating in a general environment can find data attempting access, and through this, a general virtual address translation task not requiring security isolation may be performed.

In some embodiments, the system memory management module 110 may process a transaction layer packet (TLP) received from a VF, and control access to the secure region 112 or the non-secure region 114 based on information included in the packet. For example, a specific field (e.g., a t-bit) included in header information of a TLP may be checked, so that access to the secure region 112 is allowed for a transaction requiring security, and a transaction not requiring security is mapped to the non-secure region 114. However, the present disclosure is not limited thereto, and various methods in which the system memory management module 110 distinguishes a VF managed in a TEE environment and a VF managed in a general environment, and controls a memory region accessible by each VF may be applied. For example, if a specific VF (e.g., the first VF 101a) is assigned to a TEE VM, the corresponding VF may be set to access only the secure region 112, while a general VF (e.g., the second VF 101b, the third VF 101c) may be restricted to access only the non-secure region 114.

The volatile memory 120 may include a memory for storing and/or processing data and/or software of a process running in the electronic device 100. That is, data in use may be stored in the volatile memory 120. For example, data used for an artificial intelligence (AI) operation may be stored in the volatile memory 120. According to an embodiment, the volatile memory 120 may include at least one of SRAM (static RAM) or DRAM (dynamic RAM).

The volatile memory 120 may be divided into a secure region 122 and a non-secure region 124. The secure region 122 may be allocated as a space for storing a page table of a VF (e.g., the first VF 101a) operating in a trusted execution environment (TEE), and through this, an address translation accessed by a TEE VM may be performed in a secure environment. The non-secure region 124 may be utilized as a space where page tables and data of VFs (e.g., the second VF 101b, the third VF 101c) executed in a general environment are stored, and data used by a TEE VM may also be stored in an encrypted state. That is, data itself of a VF assigned to a TEE VM may be stored in the non-secure region 124, but a page table for finding the corresponding data may be stored in the secure region 122. Through such a structure, only a page table manager managing a page table stored in the secure region 122 is restricted to convert a virtual address of a TEE VM into a physical address, and through this, access to data of a TEE VM by an unauthorized entity may be prevented.

In some embodiments, an access authority to the secure region 122 of the volatile memory 120 may be granted only to a root of trust (RoT) of the electronic device 100. The RoT may include the device security manager 100a whose reliability is verified by the host device 102. Also, access is possible even in the secure region 112 of the system memory management module 110, so that address translation and security policy application using a page table in the secure region 122 of the volatile memory 120 may be performed.

According to some embodiments, a physical bus may be implemented in hardware so that access to the secure region 122 of the volatile memory 120 is restricted. For example, data access to the secure region 122 of the volatile memory 120 may be designed to be possible only through a specific secure interconnect, and the corresponding interconnect may be configured to be accessible only by a trustworthy component (e.g., the device security manager 100a, the secure region 112 of the system memory management module 110) in the electronic device 100. Through this, direct access to the secure region 122 of the volatile memory 120 by a general processor or a VM executed in a non-secure environment may be prevented, and a trusted execution environment (TEE) may be effectively implemented.

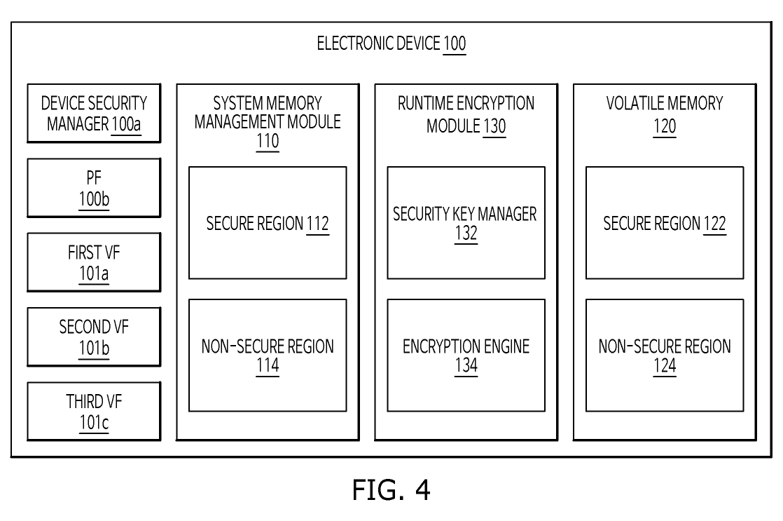

FIG. 4 illustrates an electronic device according to some embodiments of the present disclosure. Descriptions overlapping with the above description are briefly described or omitted.

Referring to FIG. 4, the electronic device 100 may include a device security manager 100a, a PF 100b, a plurality of VFs 101a-101c, a system memory management module 110, a volatile memory 120, and a runtime encryption module 130. Compared to the electronic device 100 of FIG. 3, the electronic device 100 may further include the runtime encryption module 130.

The runtime encryption module 130 may perform data encryption and decryption in real time to maintain data security of a VF executed in a TEE environment within the electronic device 100. Through this, confidentiality of data between TEE VMs is protected, and unauthorized access may be prevented. The runtime encryption module 130 may include a security key manager 132 and an encryption engine 134.

The device security manager 100a may be configured to assign a VF ID for each of the plurality of VFs. The runtime encryption module 130 may determine whether a received VF ID is assigned by the device security manager 100a, and perform data encryption or decryption in response to determining that the received VF ID is assigned by the device security manager 100a. Unlike this, the runtime encryption module 130 may refrain from performing data encryption or decryption in response to determining that the received VF ID is not assigned by the device security manager.

The security key manager 132 may generate and assign a different encryption key according to an ID (VF ID) of a VF executed in a TEE environment. Through this, data between VFs owned by each TEE VM is isolated, and unauthorized access to data of another VF by a specific VF may be prevented. The security key manager 132 stores an encryption key for each VF ID, and if a data encryption and decryption request of a specific VF occurs, may select an appropriate encryption key according to an ID of each VF and provide the encryption key to the encryption engine 134.

The encryption engine 134 is a hardware or software component that performs encryption and decryption operations of data, and may apply an encryption algorithm based on an encryption key provided from the security key manager 132. For example, the encryption engine 134 may encrypt data of a VF executed in a TEE environment using Advanced Encryption Standard (AES) or other authenticated encryption algorithms, and store the data in the non-secure region 124 of the volatile memory 120. Also, the encryption engine 134 may decrypt encrypted data stored in the volatile memory 120 and return the data to a requesting VF.

The runtime encryption module 130 may receive a physical address from the system memory management module 110. The runtime encryption module 130 may access a specific region of the volatile memory 120 based on the corresponding physical address. In a case of storing data, the encryption engine 134 of the runtime encryption module 130 may check a received physical address, and then record encrypted data at the corresponding address. In a case of reading data, the encryption engine 134 may decrypt data stored at a designated physical address and then provide the data to a requesting VF.

In some embodiments, the runtime encryption module 130 may check a VF ID and perform a corresponding operation only if encryption or decryption is necessary. For example, if an ID of a specific VF is not registered by the device security manager 100a, that is, in a case of a VF executed in a non-secure environment, the runtime encryption module 130 may store data in the volatile memory 120 without performing encryption and decryption operations. Through this, data of a VF executed in a TEE environment is protected through encryption, while a VF of a non-secure environment may be designed to store and access data in an existing manner.

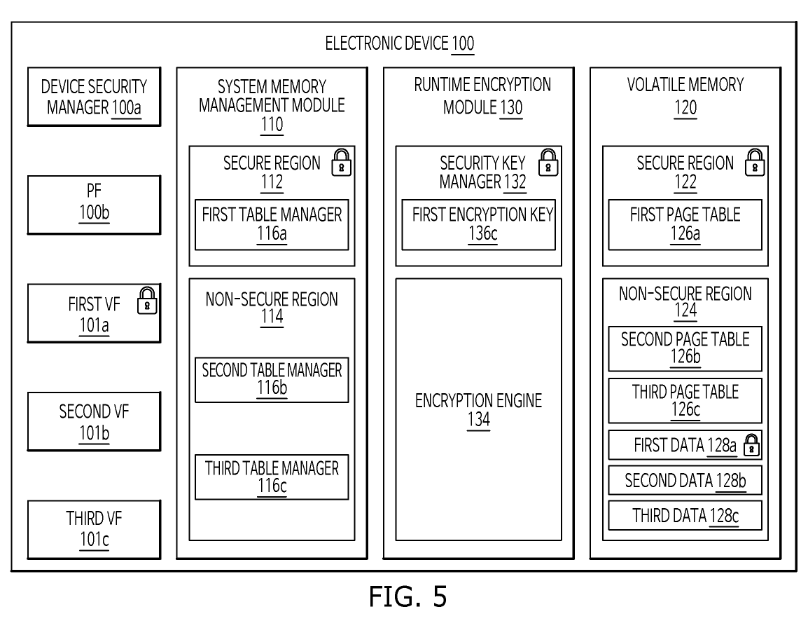

FIG. 5 illustrates an electronic device in which a trusted execution environment is implemented according to some embodiments of the present disclosure. Descriptions overlapping with the above description are briefly described or omitted.

Referring to FIG. 5, the electronic device 100 may separate a VF operating in a TEE environment and a VF operating in a general environment to maintain security. For example, the first VF 101a is a VF assigned to a TEE VM (e.g., 103 of FIG. 2) of a host device and operates in a TEE environment, and the first VF 101a may be associated with a first table manager 116a, a first page table 126a, a first encryption key 136c, and first data 128a, respectively. Also, the second VF 101b and the third VF 101c operate in a general environment, and may be associated with a second table manager 116b, a second page table 126b, second data 128b, and a third table manager 116c, a third page table 126c, and third data 128c, respectively.

Looking at a process in which a trusted execution environment is implemented in the electronic device 100, first, the device security manager 100a may perform an authentication procedure for the electronic device 100 based on a host security manager and a security protocol. In this process, the security protocol may include a Security Protocol and Data Model (SPDM) based protocol, and through this, integrity and reliability of the electronic device 100 may be verified. Only if the authentication procedure is approved, subsequent VF assignment and security policy application may be performed.

If the authentication procedure is completed, the host security manager (e.g., 102a of FIG. 2) may transmit a request for the first VF 101a to the device security manager 100a to assign a TEE VM for processing secure data to a specific VF. In response to receiving the request for the first VF 101a, the device security manager 100a may create and/or place the first table manager 116a in the secure region 112 of the system memory management module 110. For example, the device security manager 100a may newly create the first table manager 116a and store the first table manager 116a in the secure region 112 of the system memory management module 110, or delete/invalidate the first table manager 116a stored in the non-secure region 114 of the system memory management module 110 and store the first table manager 116a in the secure region 112 of the system memory management module 110.

Also, in response to receiving a request for the first VF 101a, the device security manager 100a may store the first page table 126a in the secure region 122 of the volatile memory 120. The first page table 126a may store page mapping information between a virtual address and a physical address so that a TEE VM can find data if attempting access using a virtual address.

Also, the device security manager 100a may assign a VF ID to the first VF 101a, and transmit the assigned VF ID to the runtime encryption module 130. The security key manager 132 of the runtime encryption module 130 generates and stores a different encryption key for each VF ID, and may generate and manage the first encryption key 136c corresponding to the first VF 101a.

According to various embodiments of the present disclosure, in order to access data associated with the first VF 101a operating in a TEE environment, access to the first table manager 116a stored in the secure region 112 of the system memory management module 110 and the first page table 126a stored in the secure region 122 of the volatile memory 120 may be required. Through this, a translation from a virtual address (VA) to a physical address (PA) may be safely managed in a secure environment. In particular, a different encryption key is applied for each VF ID, so that data protection between VFs may be strengthened. By such a structure, even if a malicious attacker attempts to access secure data, the malicious attacker cannot easily access translation information between a virtual address and a physical address, and must bypass an encryption key applied for each VF ID to decrypt data of a translated physical address, so that security may be further strengthened.

Also, the process of setting a TEE environment described above may be restricted to be performed only by the device security manager 100a verified by a host device manager. For example, an authority for a task of updating the secure region 112 of the system memory management module 110, a task of changing an encryption key or an encryption algorithm of the runtime encryption module 130, a task of updating the secure region 122 of the volatile memory 120, and the like may be granted to the device security manager 100a. Through this, unauthorized change of security settings in a TEE environment is prevented, and a trustworthy execution environment may be effectively implemented.

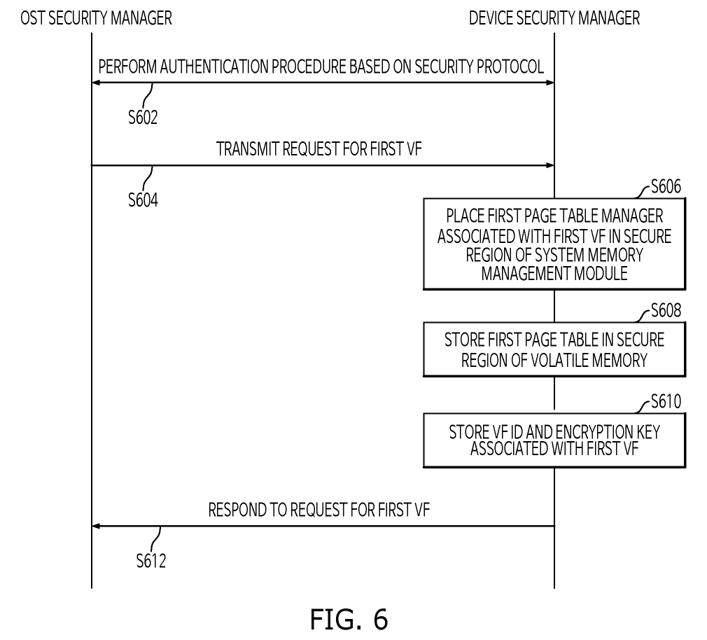

FIG. 6 illustrates a method in which a host security manager and a device security manager verify reliability of an electronic device and assign a VF operating in a TEE environment according to some embodiments of the present disclosure.

Referring to FIG. 6, a host security manager (e.g., the host security manager 102a of FIG. 2) included in a host device (e.g., the host device 102 of FIG. 2) and a device security manager (e.g., the device security manager 100a of FIG. 2) included in an electronic device (e.g., the electronic device 100 of FIG. 2) may perform an authentication procedure for the electronic device based on a security protocol (S602). Here, the host security manager may be a most trusted root in the host device, and the device security manager may be a most trusted root in the electronic device. In some embodiments, the security protocol may include a protocol based on a security protocol and data model (SPDM). After authentication based on the SPDM protocol is passed, VF assignment in a TEE environment may be made.

Also, the host security manager may transmit a request for a first VF to the device security manager (S604). The host security manager may transmit the request for the first VF to the device security manager to assign a TEE VM for processing secure data to a specific VF. In response to receiving the request for the first VF from the host security manager, the device security manager may perform security setting of the first VF.

In response to receiving the request for the first VF, the device security manager may place a first table manager associated with the first VF in a secure region (e.g., the secure region 112 of FIG. 3) of a system memory management module (e.g., the system management module 110 of FIG. 3) (S606). Also, in response to receiving the request for the first VF, the device security manager may store a first page table in a secure region (e.g., the secure region 122 of FIG. 3) of a volatile memory (e.g., the volatile memory 120 of FIG. 3) (S608). Through such a configuration, a translation between a virtual address and a physical address in a TEE environment may be managed in a secure environment.

Also, in response to receiving the request for the first VF, the device security manager may assign a VF ID associated with the first VF, and store an encryption key for the corresponding VF ID (S610). In some embodiments, the device security manager may store the VF ID associated with the first VF in a runtime encryption module (e.g., the runtime encryption module 130 of FIG. 4). Also, the device security manager may control the runtime encryption module to generate and store an encryption key corresponding to the VF ID of the first VF. Through this, data of a TEE VM executed in a TEE environment is encrypted and protected, and isolation from data of a VM of a general environment may be maintained.

Also, if VF assignment is completed, the device security manager may respond to the host security manager regarding the request for the first VF (S612). Through this, the first VF may be set to operate in a trustworthy state within a TEE environment.

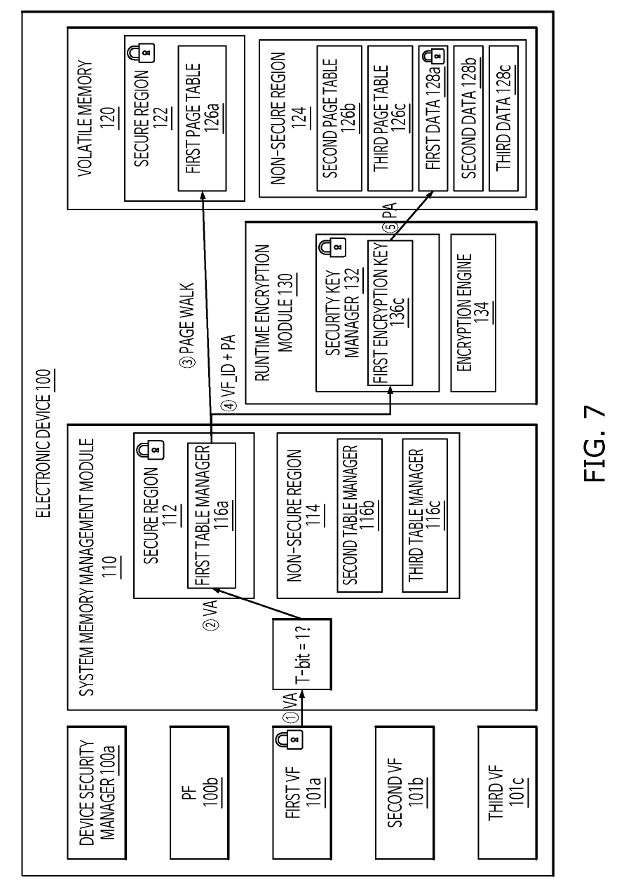

FIG. 7 illustrates a process in which a VF operating in a TEE environment accesses data according to some embodiments of the present disclosure. Descriptions overlapping with the above description are briefly described or omitted.

Referring to FIG. 7, the first VF 101a is a VF assigned to a TEE VM of the host device, and the first VF 101a may access data stored in the volatile memory 120 using a virtual address received from the TEE VM of the host device.

The first VF 101a executed in a TEE environment may transmit a virtual address (VA) to the system memory management module 110 to store data in the volatile memory 120 or read data stored in the volatile memory 120. At this time, the first VF 101a may transmit the virtual address together with a transaction layer packet (TLP). The system memory management module 110 may control secure region access based on header information of the TLP. In some embodiments, the system memory management module 110 may determine whether to access a secure region based on a t-bit value. For example, if a t-bit of a TLP is 1, access to the secure region 112 is allowed, and if a t-bit of a TLP is 0, access to the secure region 112 is blocked, and only access to the non-secure region 114 may be allowed. The first VF 101a may transmit a request by setting a t-bit to 1 to access data of a secure region.

The first VF 101a may transmit a virtual address (VA) to the system memory management module 110 by setting a t-bit to 1, and at this time, the first table manager 116a of the secure region 112 may perform address translation based on the received virtual address. The first table manager 116a checks whether translation information for the received virtual address is stored in the secure region 112, and if translation information exists, may convert the virtual address (VA) into a physical address (PA). If translation information does not exist, the first table manager 116a may access the secure region 122 of the volatile memory 120 to perform a page walk. For example, the first table manager 116a may load the first page table 126a stored in the secure region 122 of the volatile memory 120 to update translation information, and then convert a virtual address (VA) into a physical address (PA). An access authority to the secure region 122 of the volatile memory 120 may be allowed if performing a page walk in the secure region 112 of the system memory management module 110.

According to some embodiments, a physical bus may be implemented in hardware so that access to the secure region 122 of the volatile memory 120 is restricted. For example, data access to the secure region 122 of the volatile memory 120 may be designed to be possible only through a specific secure interconnect, and the corresponding interconnect may be configured to be accessible only by a trustworthy component (e.g., the device security manager 100a, the secure region 112 of the system memory management module 110) in the electronic device 100.

If address translation to a physical address (PA) is completed, the first table manager 116a may transmit the translated physical address (PA) and a VF ID of the first VF 101a to the runtime encryption module 130. The security key manager 132 of the runtime encryption module 130 may retrieve the first encryption key 136c assigned to the corresponding VF based on the received VF ID, and provide the first encryption key 136c to the encryption engine 134. After encrypting data using the first encryption key 136c, the encryption engine 134 may store encrypted data (e.g., the first data 128a) in a specific region (e.g., the non-secure region 124) of the volatile memory 120 corresponding to the translated physical address (PA). Unlike this, the encryption engine 134 may decrypt data stored in a region corresponding to the physical address (PA) of the volatile memory 120 through the first encryption key 136c.

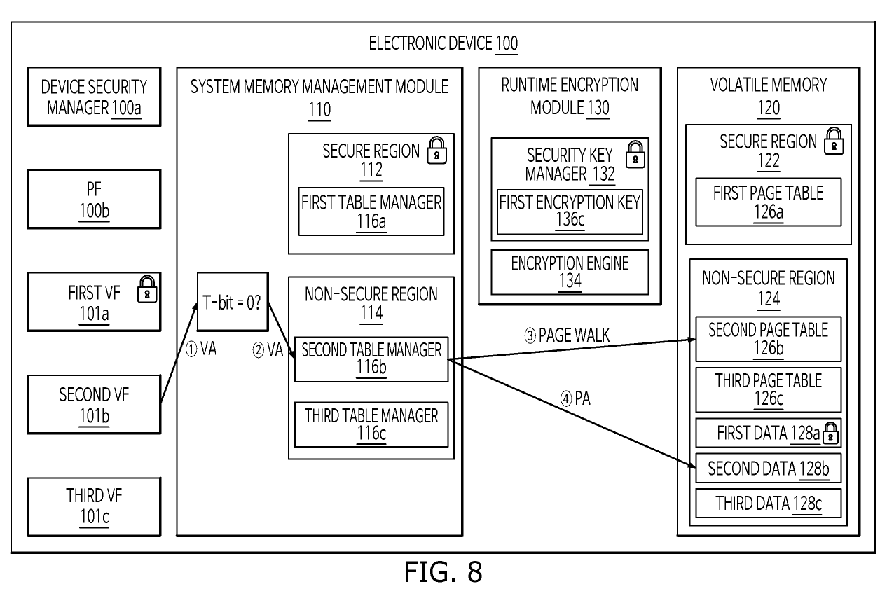

FIG. 8 illustrates a process in which a VF operating in a general environment accesses data according to some embodiments of the present disclosure. Descriptions overlapping with the above description are briefly described or omitted.

Referring to FIG. 8, the second VF 101b and the third VF 101c operate in a general environment, and may access data stored in the volatile memory 120 using a virtual address received from a legacy VM (e.g., 103b, 103c of FIG. 2) of the host device. Hereinafter, a process in which the second VF 101b accesses data is described as an example.

The second VF 101b executed in a general environment may transmit a virtual address to the system memory management module 110 to store data in the volatile memory 120 or read data stored in the volatile memory 120, and at this time, may transmit a request together with a transaction layer packet (TLP). The system memory management module 110 may control access to the secure region 112 and the non-secure region 114 based on header information of the TLP. Since the second VF 101b is a VF operating in a general environment where access to data of a secure region is impossible, the second VF 101b may transmit a request by setting a t-bit to 0. Accordingly, the second VF 101b may access the second table manager 116b of the non-secure region 114.

After checking whether translation information for the received virtual address is stored in the non-secure region 114, the second table manager 116b may immediately convert to a physical address if translation information exists. If translation information does not exist, the second table manager 116b may access the non-secure region 124 of the volatile memory 120 to perform a page walk, update translation information, and then convert the virtual address into a physical address. In this process, the second table manager 116b may access the second page table 126b stored in the non-secure region 124 of the volatile memory 120. The second page table 126b stored in the non-secure region 124 of the volatile memory 120 provides address translation for a VF executed in a general environment, and since security verification is not performed in this process, may operate at a relatively lower security level than accessing the secure region 122.

The second VF 101b executed in a general environment may convert a virtual address into a physical address, and then access a specific data region (e.g., the non-secure region 124) of the volatile memory 120 through the translated physical address (PA), and may read or store general data such as the second data 128b. As shown in FIG. 8, a VF executed in a general environment may store or access data as it is without an encryption process applying an encryption key, and access to the secure region 112 of the system memory management module 110 and the secure region 122 of the volatile memory 120 may be restricted.

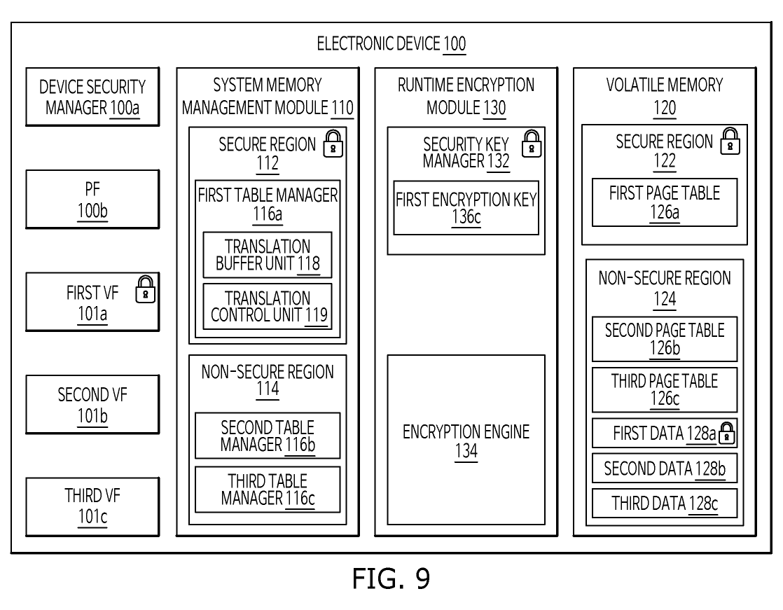

FIG. 9 illustrates components of a table manager according to some embodiments of the present disclosure. Descriptions overlapping with the above description are briefly described or omitted.

Referring to FIG. 9, the first table manager 116a may include a translation buffer unit (TBU) 118 and a translation control unit (TCU) 119. Although not shown, each of the second table manager 116b and the third table manager 116c may include a translation buffer unit and a translation control unit.

The translation buffer unit 118 may perform a role of checking whether translation information for a virtual address is cached. If translation information for a virtual address exists, the translation buffer unit 118 may immediately convert the corresponding virtual address into a physical address, and through this, address translation may be performed quickly. The translation buffer unit 118 may include a cache memory, and store recently translated VA-PA mapping information to more efficiently process repetitive translation requests for the same address.

If translation information for a virtual address does not exist, the translation control unit 119 may perform a page walk to search for and update translation information, and then convert a virtual address into a physical address. The translation control unit 119 may access the first page table 126a stored in the secure region 122 of the volatile memory 120 to update translation information.

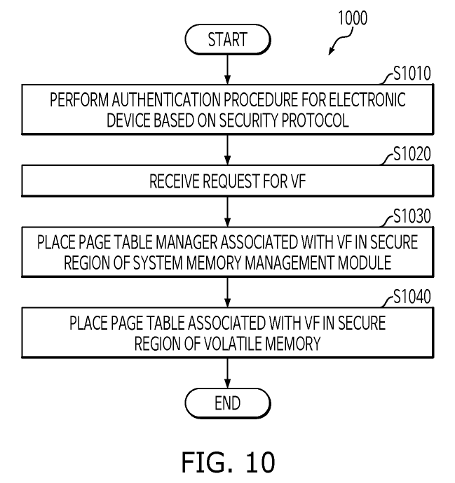

FIG. 10 illustrates a method for implementing a trusted execution environment according to some embodiments of the present disclosure. A method 1000 for implementing a trusted execution environment may be performed by a device security manager (e.g., the device security manager 100a of FIG. 2) of an electronic device (e.g., the electronic device 100 of FIG. 2).

Referring to FIG. 10, the device security manager may perform an authentication procedure for the electronic device based on a security protocol (S1010). The device security manager may perform an authentication procedure for the electronic device with a host security manager (e.g., the host security manager 102a of FIG. 2) included in a host device (e.g., the host device 102 of FIG. 2). Here, the host security manager may be a most trusted root in the host device, and the device security manager may be a most trusted root in the electronic device. In some embodiments, the security protocol may include a protocol based on a security protocol and data model (SPDM).

Also, the device security manager may receive a request for a VF (S1020). The host security manager may transmit a request for a VF to the device security manager to assign a TEE VM for processing secure data to a specific VF. The device security manager may determine whether the request for a VF received from the host security manager relates to a TEE VM for processing secure data. If determining that the request for a VF received from the host security manager relates to a TEE VM for processing secure data, the device security manager may perform security setting for the corresponding VF.

Also, in response to receiving the request for a VF, the device security manager may place a table manager associated with the corresponding VF in a secure region (e.g., the secure region 112 of FIG. 3) of a system memory management module (e.g., the system management module 110 of FIG. 3) (S1030). Also, in response to receiving the request for a VF, the device security manager may store a page table associated with the corresponding VF in a secure region (e.g., the secure region 122 of FIG. 3) of a volatile memory (e.g., the volatile memory 120 of FIG. 3) (S1040). The page table associated with the corresponding VF may include mapping information between a virtual address and a physical address for a memory region assigned to the corresponding VF.

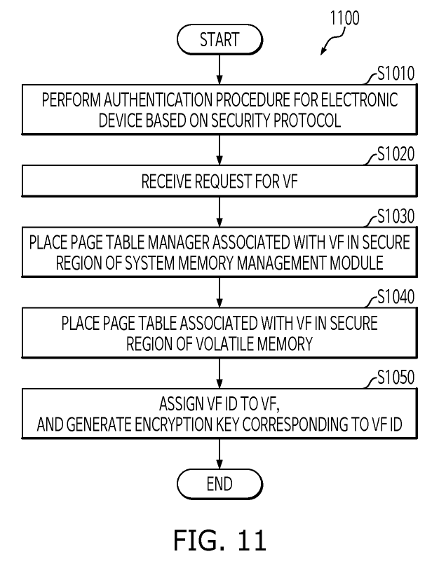

FIG. 11 illustrates a method for implementing a trusted execution environment according to some embodiments of the present disclosure. Descriptions overlapping with the above description are briefly described or omitted. A method 1000 for implementing a trusted execution environment may be performed by a device security manager (e.g., the device security manager 100a of FIG. 2) of an electronic device (e.g., the electronic device 100 of FIG. 2). Compared to the method 1000 of FIG. 10, a method 1100 for implementing a trusted execution environment of FIG. 11 may further include step S1050.

The device security manager may perform an authentication procedure for the electronic device based on a security protocol (S1010), receive a request for a VF (S1020), place a page table manager associated with the VF in a secure region of the system memory management module (S1030), and place a page table associated with the VF in a secure region of the volatile memory (S1040).

Also, in response to receiving the request for a VF, the device security manager may assign a VF ID associated with the VF, and generate and store an encryption key for the corresponding VF ID (S1050). In some embodiments, the device security manager may store the VF ID associated with the VF in a runtime encryption module (e.g., the runtime encryption module 130 of FIG. 4). Also, the device security manager may control the runtime encryption module to generate and store an encryption key corresponding to the VF ID of the VF.

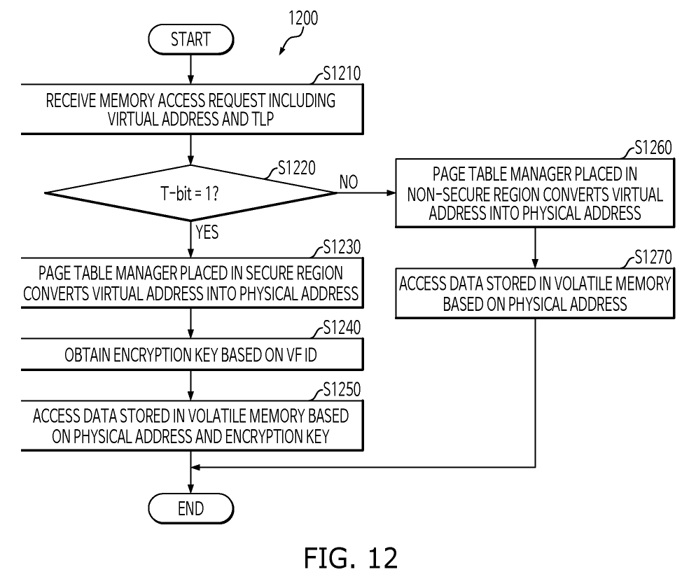

FIG. 12 illustrates a method for accessing data in a TEE environment according to some embodiments of the present disclosure. A method 1200 for accessing data in a TEE environment may be performed by an electronic device (e.g., the electronic device 100 of FIG. 2).

Referring to FIG. 12, a system memory management module (e.g., the system memory management module 110 of FIG. 3) of the electronic device may receive a memory access request including a virtual address and a TLP (S1210). For example, the system memory management module may receive the corresponding request from a VF operating in a TEE environment, or receive the corresponding request from a VF operating in a general environment.

Also, the system memory management module may determine whether a value of a t-bit is 1 based on header information of the TLP (S1220). However, the scope of the present disclosure is not limited thereto, and various methods in which the system memory management module distinguishes a VF managed in a TEE environment and a VF managed in a general environment and controls a memory region accessible by each VF may be applied.

In response to the system memory management module determining that the value of the t-bit is 1 (YES), a page table manager placed in a secure region of the system memory management module may convert the virtual address into a physical address (S1230). In some embodiments, the page table manager placed in the secure region of the system memory management module may access a page table stored in a secure region of the volatile memory to convert the virtual address into a physical address. The page table manager placed in the secure region of the system memory management module may transmit a VF ID associated with the corresponding VF together with the converted physical address to a runtime encryption module.

Also, the runtime encryption module may obtain an encryption key based on the received VF ID (S1240). Also, the runtime encryption module may access data stored in the volatile memory based on the physical address and the encryption key (S1250). As an example, the runtime encryption module may access a memory region of the volatile memory using the physical address, and decrypt data stored in the corresponding memory region using the encryption key.

On the other hand, in response to the system memory management module determining that the value of the t-bit is 0 (NO), a page table manager placed in a non-secure region of the system memory management module may convert the virtual address into a physical address (S1260). In some embodiments, the page table manager placed in the non-secure region of the system memory management module may access a page table stored in a non-secure region of the volatile memory to convert the virtual address into a physical address.

Also, the page table manager placed in the non-secure region of the system memory management module may access data stored in the volatile memory based on the physical address (S1270).

The above-described flowcharts and the above-described description are merely examples, and may be implemented differently in some embodiments. For example, in some embodiments, an order of each step may be changed, some steps may be repeatedly performed, some steps may be omitted, or some steps may be added.

The above-described method may be provided as a computer program stored in a computer-readable recording medium for execution on a computer. The medium may be one that continuously stores a program executable by a computer, or temporarily stores a program for execution or download. Also, the medium may be various recording means or storage means in a form where single or several hardware are combined, and is not limited to a medium directly connected to any computer system, but may exist distributed on a network. Examples of the medium may include magnetic media such as hard disks, floppy disks, and magnetic tapes, optical recording media such as CD-ROMs and DVDs, magneto-optical media such as floptical disks, and things configured to store program instructions including ROM, RAM, flash memory, and the like. Also, as examples of other media, recording media or storage media managed by app stores distributing applications or sites, servers, etc. supplying or distributing other various software may be included.

Methods, operations, or techniques of the present disclosure may be implemented by various means. For example, these techniques may be implemented in hardware, firmware, software, or a combination thereof. Those skilled in the art will understand that various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in various ways for each particular application, but such implementations should not be interpreted as causing a departure from the scope of the present disclosure.

In a hardware implementation, processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device, and the like. The instructions may be executable by one or more processors and may cause the processor(s) to perform certain aspects of the functionality described in the present disclosure.

If implemented in software, the above-described techniques may be stored on a computer-readable medium as one or more instructions or code, or transmitted via a computer-readable medium. Computer-readable media include both computer storage media and communication media including any medium that facilitates transfer of a computer program from one place to another. Storage media may be any available media that can be accessed by a computer. By way of non-limiting example, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using wireless technologies such as coaxial cable, fiber optic cable, twisted pair, digital subscriber line (DSL), or infrared, radio, and microwave, then the coaxial cable, fiber optic cable, twisted pair, digital subscriber line, or wireless technologies such as infrared, radio, and microwave are included in the definition of medium. Disk and disc, as used herein, includes CD, laser disc, optical disc, digital versatile disc (DVD), floppy disk, and Blu-ray disc, where disks usually reproduce data magnetically, while discs reproduce data optically using lasers. Combinations of the above should also be included within the scope of computer-readable media.

A software module may reside in RAM memory, flash memory, ROM memory, EPROM memory, EEPROM memory, registers, hard disk, removable disk, CD-ROM, or any other form of storage medium known. An exemplary storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the embodiments described above have been described as utilizing aspects of the presently disclosed subject matter in one or more standalone computer systems, the present disclosure is not limited thereto, and may be implemented in conjunction with any computing environment, such as a network or distributed computing environment. Furthermore, aspects of the subject matter in the present disclosure may be implemented in a plurality of processing chips or devices, and storage may be similarly effected across a plurality of devices. Such devices may include PCs, network servers, and portable devices.

Although the present disclosure has been described in connection with some embodiments herein, various modifications and changes can be made without departing from the scope of the present disclosure understandable by those skilled in the art to which the present disclosure belongs. Also, such modifications and changes should be considered to fall within the scope of the claims appended hereto.

What is claimed is:

1. An electronic device for implementing a trusted execution environment (TEE), comprising:
a volatile memory including a secure region;
a system memory management module configured to manage access to the volatile memory; and
a device security manager (DSM) configured to communicate with a host security manager (HSM) of a host device,
wherein the device security manager is further configured to:
perform an authentication procedure for the electronic device based on a security protocol,
receive a request for a first virtual function (VF) from the host security manager,
place a first page table manager managing a first page table associated with the first VF in a secure region of the system memory management module in response to receiving the request for the first VF, and
store the first page table in a secure region of the volatile memory, and
wherein an access authority to the secure region of the volatile memory is granted to a root of trust (RoT) of the electronic device.

2. The electronic device as claimed in claim 1, wherein the access authority to the secure region of the volatile memory is granted to at least one of the device security manager or the first page table manager.

3. The electronic device as claimed in claim 1, wherein the device security manager is further configured to assign a VF ID for each of a plurality of VFs including the first VF, and
the electronic device further comprises a runtime encryption module configured to generate a different encryption key for each VF ID, and encrypt data based on the VF ID and the encryption key corresponding to the VF ID.

4. The electronic device as claimed in claim 3, wherein the first page table manager is configured to:
receive a virtual address from the first VF to convert the virtual address into a physical address, and
transmit a first VF ID corresponding to the first VF and the physical address to the runtime encryption module, and
wherein the runtime encryption module is further configured to encrypt data through a first encryption key corresponding to the first VF ID to store the data in a region corresponding to the physical address of the volatile memory, or decrypt data stored in the region corresponding to the physical address of the volatile memory through the first encryption key.

5. The electronic device as claimed in claim 4, wherein the runtime encryption module is further configured to:
determine whether a received VF ID is assigned by the device security manager,
perform data encryption or decryption in response to determining that the received VF ID is assigned by the device security manager, and
refrain from performing data encryption or decryption in response to determining that the received VF ID is not assigned by the device security manager.

6. The electronic device as claimed in claim 1, wherein the first VF is configured to transmit, to the system memory management module, a transaction layer packet (TLP) including a virtual address and data associated with the virtual address, and
the system memory management module is further configured to control access to the secure region of the system memory management module based on header information included in the transaction layer packet.

7. The electronic device as claimed in claim 6, wherein the system memory management module is further configured to:
allow access to the secure region of the system memory management module if a t-bit of the transaction layer packet is 1, and
block access to the secure region of the system memory management module if the t-bit of the transaction layer packet is 0.

8. The electronic device as claimed in claim 6, wherein the first page table manager of the system memory management module comprises:
a translation buffer unit (TBU) configured to perform a translation for the virtual address; and
a translation control unit (TCU) configured to access the secure region of the volatile memory to perform a page walk if translation information for the virtual address does not exist in the translation buffer unit.

9. The electronic device as claimed in claim 8, further comprising a second page table manager placed in a non-secure region of the system memory management module,
wherein access of the second page table manager to the secure region of the volatile memory is blocked.

10. The electronic device as claimed in claim 6, wherein the first page table manager stores data in a region corresponding to a physical address corresponding to the virtual address of the volatile memory.

11. The electronic device as claimed in claim 1, wherein the security protocol comprises a protocol based on a security protocol and data model (SPDM).

12. A method for implementing a trusted execution environment, performed by an electronic device, comprising:
performing, by a device security manager of the electronic device, an authentication procedure for the electronic device based on a security protocol;
receiving, by the device security manager, a request for a first virtual function (VF) from a host security manager of a host device, wherein the first VF corresponds to a first trusted execution environment virtual machine (TEE VM) included in the host device;
placing, by the device security manager, a first page table manager managing a first page table associated with the first VF in a secure region of a system memory management module in response to receiving the request for the first VF; and
storing, by the device security manager, the first page table in a secure region of a volatile memory,
wherein an access authority to the secure region of the volatile memory is granted to a root of trust (RoT) of the electronic device.

13. The method as claimed in claim 12, wherein the access authority to the secure region of the volatile memory is granted to at least one of the device security manager or the first page table manager.

14. The method as claimed in claim 12, further comprising:
assigning, by the device security manager, a VF ID for each of a plurality of VFs including the first VF; and
by a runtime encryption module of the electronic device, generating a different encryption key for each VF ID, and encrypting data based on the VF ID and the encryption key corresponding to the VF ID.

15. The method as claimed in claim 14, further comprising:
receiving, by the first page table manager, a virtual address from the first VF to convert the virtual address into a physical address;
transmitting, by the first page table manager, a first VF ID corresponding to the first VF and the physical address to the runtime encryption module; and
by the runtime encryption module, encrypting data through a first encryption key corresponding to the first VF ID to store the data in a region corresponding to the physical address of the volatile memory, or decrypting data stored in the region corresponding to the physical address of the volatile memory through the first encryption key.

16. The method as claimed in claim 12, further comprising:
transmitting, by the first VF, a transaction layer packet including a virtual address and data associated with the virtual address to the system memory management module; and
controlling, by the system memory management module, access to the secure region of the system memory management module based on header information included in the transaction layer packet.

17. The method as claimed in claim 16, further comprising:
performing, by a translation buffer unit of the first page table manager, a translation for the virtual address; and
accessing, by a translation control unit of the first page table manager, the secure region of the volatile memory to perform a page walk if translation information for the virtual address does not exist in the translation buffer unit.

18. The method as claimed in claim 17, wherein a second page table manager is placed in a non-secure region of the system memory management module, and access of the second page table manager to the secure region of the volatile memory is blocked.

19. The method as claimed in claim 16, further comprising:
storing, by the first page table manager, data in a region corresponding to a physical address corresponding to the virtual address of the volatile memory.

20. The method as claimed in claim 12, wherein the security protocol comprises a protocol based on SPDM.
